(19) United States
(12) Patent Application Publication
(10) Pub. No.: US 2026/0008647 A1
(43) Pub. Date: Jan. 8, 2026

(54) CABLE BUNDLE, CABLE BUNDLE MANUFACTURING METHOD, AND CABLE BUNDLE MANUFACTURING APPARATUS

(71) Applicant: FUJIKURA LTD., Tokyo (JP)

(72) Inventors: Naoya Maehara, Chiba (JP); Shengyang Luo, Chiba (JP); Akira Namazue, Chiba (JP)

(73) Assignee: FUJIKURA LTD., Tokyo (JP)

(21) Appl. No.: 19/131,147

(22) PCT Filed: Nov. 20, 2023
(86) PCT No.: PCT/JP2023/041683

§ 371 Date: May 19, 2025

(30) Foreign Application Priority Data
Nov. 24, 2022 (JP) 2022-187748

(51) Int. Cl. B65H 55/04; B65H 54/70

(52) U.S. Cl. CPC B65H 55/04; B65H 54/70; B65H 2701/32

(57) ABSTRACT

A cable bundle includes a cable that is wound. The cable bundle includes unit bundles stacked in a stacking direction perpendicular to a first direction that is a circumferential direction of the cable bundle. Each of the unit bundles includes a first loop and a second loop that are stacked in the stacking direction, and the first loop and the second loop are connected via a respective one of connecting parts such that a figure-8 shaped loop including the first loop and the second loop is formed in a state in which each of the unit bundles is opened. The connecting parts of adjacent ones of the unit bundles in the stacking direction are disposed at different positions in the first direction.

### CROSS-REFERENCE TO RELATED APPLICATIONS

The present application claims priority from Japanese Patent Application No. 2022-187748 filed on Nov. 24, 2022, the contents of which are incorporated herein by reference in their entirety.

### BACKGROUND

### Technical Field

The present invention relates to a cable bundle, a method of manufacturing the cable bundle, and a cable bundle manufacturing apparatus.

### Description of Related Art

As a method of winding a cable, a so-called “figure-8 (figure-eight) winding” is known, in which the cable is wound while forming loops by twisting the cable alternately clockwise and counterclockwise (for example, refer to Patent Document 1). In the “figure-8 winding”, when the cable is extended by unwinding the first and second loops, no twist occurs in the cable because the helical twist generated when unwinding the first loop (the second loop) cancels the twist applied when making the second loop (the first loop).

### PATENT DOCUMENT

PATENT DOCUMENT 1: JP 2017-5840 A1

When the cable is continuously wound in the “figure-8 winding” described above, the intersections of the cable overlap in the winding direction of the cable. For this reason, if the cable has high bending rigidity, a loop being to be unwound later may lift up when the cable is unwound from the cable bundle, and the cable may be tangled and kinking may be caused in the cable. In particular, this phenomenon tends to occur frequently when the cable bundle is housed in a container and the cable is pulled out from the opening of the container.

### SUMMARY

One or more embodiments of the present invention provide a cable bundle, a method of manufacturing the cable bundle, and a cable bundle manufacturing apparatus capable of suppressing the lifting of the loop.

[1] An aspect 1 of the present invention is a cable bundle comprising: a cable that is wound; unit bundles stacked in a second direction (i.e., stacking direction) perpendicular to a first direction that is a circumferential direction of the cable bundle; connecting parts, wherein each of the unit bundles comprises a first loop and a second loop that are stacked in the second direction, the first loop and the second loop are connected via a respective one of the connecting parts such that a figure-8 shaped loop including the first loop and the second loop is formed in a state in which each of the unit bundles is opened, and the connecting parts of adjacent ones of the unit bundles in the second direction are disposed at different positions in the first direction.

[2] An aspect 2 of the present invention may be the cable bundle of the aspect 1, wherein the connecting parts of adjacent ones of the unit bundles in the second direction may be disposed at different positions within a range of 90 degrees to 270 degrees in the first direction.

[3] An aspect 3 of the present invention may be the cable bundle of the aspect 1 or 2, wherein each of the unit bundles may be formed by folding the figure-8 shaped loop including the first loop and the second loop at each of the connecting parts.

[4] An aspect 4 of the present invention may be the cable bundle of any one of the aspects 1 to 3, comprising an intermediate part that is interposed between the unit bundles and connects the unit bundles to each other, wherein the intermediate part may be wound in the first direction such that the connecting parts of adjacent ones of the unit bundles in the second direction are disposed at different positions in the first direction.

[5] An aspect 5 of the present invention may be the cable bundle of the aspect 4, wherein the intermediate parts may be wound in the first direction such that the connecting parts of adjacent ones of the unit bundles in the second direction are disposed at different positions within a range of 90 degrees to 270 degrees in the first direction.

[6] An aspect 6 of the present invention may be the cable bundle of the aspect 4 or 5, wherein the intermediate part may have a length of ¼ to ¾ of a circumference of the first loop or the second loop connected to the intermediate part.

[7] An aspect 7 of the present invention may be the cable bundle of any one of the aspects 1 to 6, wherein the unit bundles may include: a first unit bundle; a second unit bundle stacked on the first unit bundle; and a third unit bundle stacked on the second unit bundle, the cable bundle may comprise: a first intermediate part that is interposed between the first unit bundle and the second unit bundle and connects the first unit bundle and the second unit bundle to each other; and a second intermediate part that is interposed between the second unit bundle and the third unit bundle and connects the second unit bundle and the third unit bundle to each other, the first intermediate part and the second intermediate part may be wound in the first direction, and the first intermediate part and the second intermediate part may be disposed at different positions in the first direction.

[8] An aspect 8 of the present invention may be the cable bundle of any one of the aspects 1 to 7, comprising an intermediate part that is interposed between the unit bundles, connects the unit bundles to each other, and is wound in the first direction, wherein the cable may have an opposite twist opposite to a twist caused by the intermediate part when the cable is unwound.

[9] An aspect 9 of the present invention may be the cable bundle of the aspect 8, wherein a rotation number of the opposite twist may be less than or equal to a value obtained by dividing a total length of the intermediate part by an average circumferential length of the cable bundle.

[10] An aspect 10 of the present invention may be the cable bundle of any one of the aspects 1 to 7, wherein each of the connecting parts may be a part of the cable between a first intersection of the first loop and a second intersection of the second loop, and the connecting parts may be wound in the first direction.

[11] An aspect 11 of the present invention may be the cable bundle of the aspect 10, wherein the connecting parts of adjacent ones of the unit bundles in the second direction and an intermediate part connecting the unit bundles to each other may form one circumference in the first direction.

[12] An aspect 12 of the present invention may be the cable bundle of any one of the aspects 1 to 11, wherein the first loop may be formed by winding the cable in a normal winding or a reverse winding opposite to the normal winding, and the second loop may be formed by winding the cable in the reverse winding or the normal winding.

[13] An aspect 13 of the present invention may be the cable bundle of any one of the aspects 1 to 12, wherein the unit bundles may be formed such that no twist due to the unit bundles occurs in the cable when the cable is unwound.

[14] An aspect 14 of the present invention is a method of manufacturing a cable bundle comprising a cable that is wound, the method comprising: (a) forming unit bundles each of which comprises a first loop and a second loop that are connected via a respective one of connecting parts and are stacked; and (b) stacking the unit bundles such that the connecting parts are disposed at different positions in a first direction that is a circumferential direction of the cable bundle, wherein the first loop and the second loop are connected via a respective one of the connecting parts such that a figure-8 shaped loop including the first loop and the second loop is formed in a state in which each of the unit bundles is opened.

[15] An aspect 15 of the present invention may be the method of manufacturing the cable bundle of the aspect 14, wherein step (a) may comprise: forming third loops each of which comprises the first loop and the second loop connected to each other via each of the connecting parts by disposing the cable in a figure-8 shape; and forming the unit bundles by folding each of the third loops at each of the connecting parts and stacking the first loop and the second loop.

[16] An aspect 16 of the present invention may be the method of manufacturing the cable bundle of the aspect 14, wherein step (a) may comprise: forming the first loop by twisting the cable in a third direction; forming the second loop by twisting the cable in a fourth direction opposite to the third direction; and forming each of the unit bundles by stacking the first loop and the second loop.

[17] An aspect 17 of the present invention may be the method of manufacturing the cable bundle of any one of the aspects 14 to 17, wherein step (b) may comprise stacking the unit bundles such that the connecting parts of adjacent ones of the unit bundles are disposed at different positions within a range of 90 degrees to 270 degrees in the first direction.

[18] An aspect 18 of the present invention may be the method of manufacturing the cable bundle of any one of the aspects 14 to 17, wherein the cable bundle may comprise an intermediate part that is interposed between the unit bundles and connects the unit bundles to each other, and step (b) may comprise winding the intermediate part in the first direction such that the connecting parts of adjacent ones of the unit bundles are disposed at different positions in the first direction.

[19] An aspect 19 of the present invention may be the method of manufacturing the cable bundle of the aspect 18, wherein step (b) may comprise winding the intermediate parts in the first direction such that the connecting parts of adjacent ones of the unit bundles are disposed at different positions within a range of 90 degrees to 270 degrees in the first direction.

[20] An aspect 20 of the present invention may be the method of manufacturing the cable bundle of any one of the aspects 14 to 19, wherein the intermediate part may have a length of ¼ to ¾ of a circumference of the first loop or the second loop connected to the intermediate part.

[21] An aspect 21 of the present invention is a cable bundle manufacturing apparatus that manufactures a cable bundle comprising a cable that is wound, the cable bundle manufacturing apparatus comprising: a fixer that fixes a movement of the cable in an axial direction at a fixed position on the cable; a conveyor that conveys the cable toward the fixed position; a twister that forms a loop of the cable by twisting the cable conveyed by the conveyor; a first rotator that has a placement surface on which the loop formed by the twister is placed and stacked, and rotates the placement surface about a first axis substantially parallel to a normal direction of the placement surface.

[22] An aspect 22 of the present invention may be the cable bundle manufacturing apparatus of the aspect 21, wherein the twister may form a first loop by twisting the cable in a third direction and may form a second loop by twisting the cable in a fourth direction opposite to the third direction.

[23] An aspect 23 of the present invention may be the cable bundle manufacturing apparatus of the aspect 21 or 22, comprising a second rotator that rotates a drum that supplies the cable about a second axis that is substantially parallel to a direction in which the cable is conveyed from the drum.

According to one or more embodiments of the present invention, since the connecting parts of adjacent ones of the unit bundles in the second direction are disposed at different positions in the first direction, it is possible to suppress the lifting of the loop being to be unwound later. According to one or more embodiments of the present invention, since the first rotator rotates the placement surface on which the loop of the cable is placed, it is possible to manufacture the cable bundle that includes the above-described connecting parts disposed at different positions in the first direction.

### BRIEF DESCRIPTION OF DRAWING(S)

FIG. 1 is a perspective view showing a cable bundle in the first embodiment of the present invention.

FIG. 2 is an enlarged side view of a part of the cable bundle shown in FIG. 1.

FIG. 3A is a schematic plan view showing a position of a first intermediate part in the circumferential direction of the cable bundle.

FIG. 3B is a schematic plan view showing a position of a second intermediate part in the circumferential direction of the cable bundle.

FIGS. 4A-4E are diagrams illustrating a method of forming a first unit bundle of the cable bundle in the first embodiment of the present invention.

FIGS. 5A-5E are diagrams illustrating a method of forming a second unit bundle of the cable bundle in the first embodiment of the present invention.

FIGS. 6A-6E are diagrams illustrating a method of forming a third unit bundle of the cable bundle in the first embodiment of the present invention.

FIG. 7 is a perspective view showing a configuration of a figure-8 shaped loop when the unit bundle is opened in the second embodiment of the present invention.

FIG. 8 is a side view showing a cable bundle in the second embodiment of the present invention and is a view corresponding to FIG. 2.

FIG. 9 is a developed view of a part of a cable bundle in the third embodiment of the present invention.

FIG. 10 is a diagram illustrating a cable bundle manufacturing apparatus in the third embodiment of the present invention.

### DETAILED DESCRIPTION OF EMBODIMENTS

Hereinafter, the embodiments of the present invention will be described with reference to the drawings.

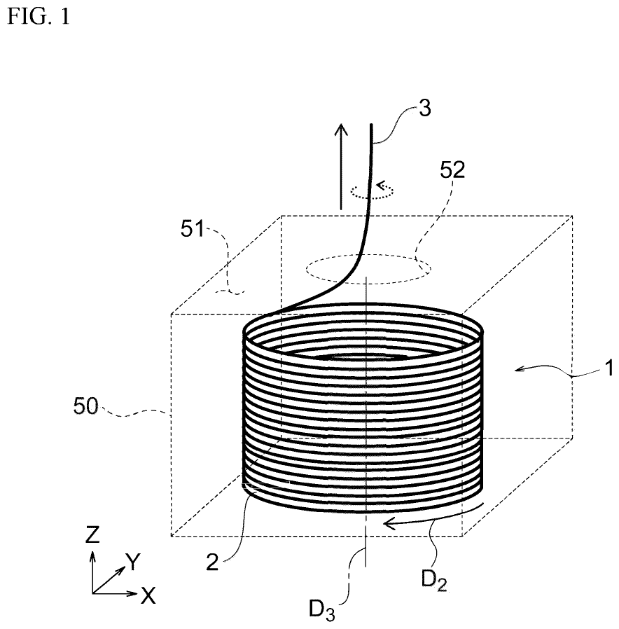

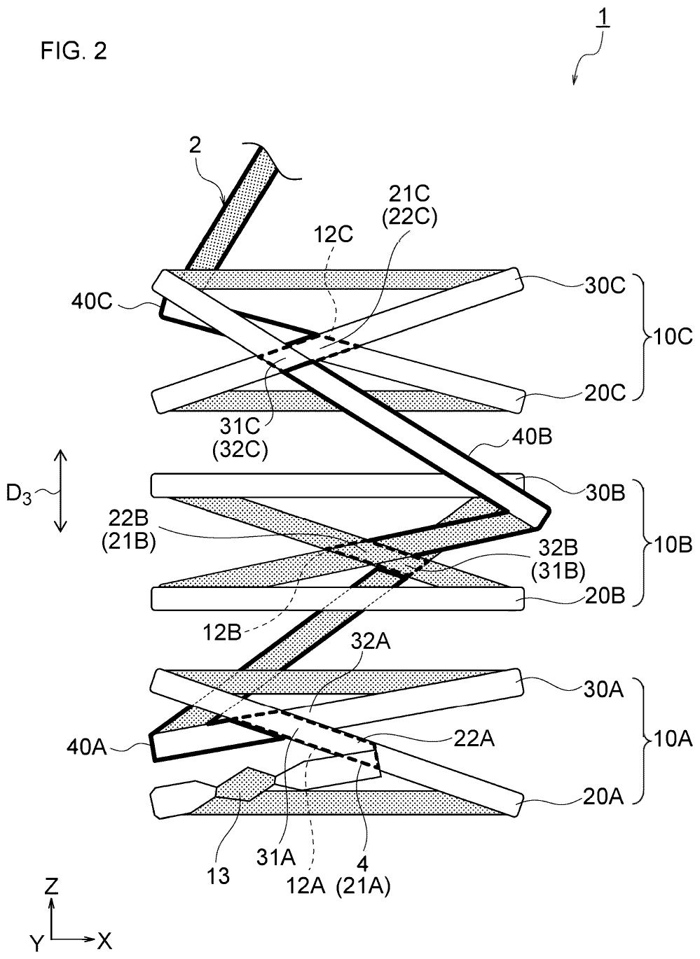

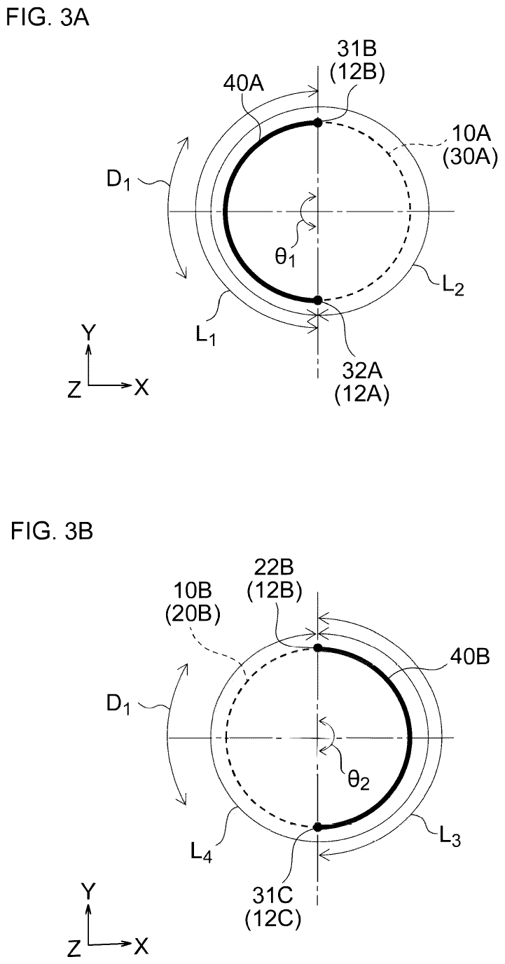

FIG. 1 is a perspective view showing a cable bundle 1 in the first embodiment of the present invention, FIG. 2 is an enlarged side view of a part of the cable bundle 1 shown in FIG. 1. FIG. 3A is a schematic plan view showing a position of a first intermediate part 40A in the circumferential direction D₁ of the cable bundle 1, and FIG. 3B is a schematic plan view showing a position of a second intermediate part 40B in the circumferential direction D₁ of the cable bundle 1.

In FIG. 1, the container 50 is shown transparently in order to facilitate understanding of the inside of the container 50. In FIG. 2, the white part in the cable 2 indicates the front side of the cable 2, the shaded part in the cable 2 indicates the rear side of the cable 2. Further, in FIG. 2, the thick solid line parts in the cable 2 indicate the intermediate parts 40A, 40B and 40C of the cable 2, the thick broken line parts in the cable 2 indicate the connecting parts 12A, 12B and 12C of the cable 2.

As shown in FIG. 1, the cable bundle 1 in the present embodiment includes a cable 2 that is wound in an annular shape (cylindrical shape, coil shape) in the winding direction D₂, and the cable bundle 1 is formed by winding a single continuous cable 2 using a winding method described later. The cable bundle 1 has a so-called drumless structure that does not have a winding core such as a drum or a reel. Although an optical fiber cable can be exemplified as a specific example of the cable 2, the cable 2 is not particularly limited thereto. For example, a metal cable for power transmission, communication, or a combination of these may be used as the cable 2. Although the cable 2 of the present embodiment has no connection point between one end portion 3 (e.g., the end of the winding end side of the cable 2 (E end)) and the other end portion 4 (e.g., the end of the winding start side of the cable 2 (S end)) (see FIG. 2), for example, a single continuous cable may be configured by connecting a plurality of cables with fusion or a connector or the like.

When installing the cable 2, for example, the cable bundle 1 is transported to the installation site while being housed in the container 50 as shown in FIG. 1. The container 50 has a box-like shape, and the container 50 has an opening 52 formed in its upper plane. Then, the cable 2 is sequentially conveyed from one end 3 to the outside of the container 50 through the opening 52, the cable 2 is supplied to the installation site. The cable bundle 1 is disposed in the container 50 in a posture (i.e., a “vertical posture”) in which the axial D₃ of the cable bundle 1 is substantially parallel to the vertical direction (Z direction in the drawing). Although not particularly limited, for example, the container 50 is formed using a cardboard made of paper. For example, the container 50 may be formed using a plastic cardboard made of a resin material such as polypropylene (PP), or the container 50 may be formed using a metallic box.

As shown in FIG. 2, the cable bundle 1 includes unit bundles 10A, 10B, 10C, . . . and intermediate parts 40A, 40B, 40C, . . . . Each of the unit bundles 10A, 10B, 10C, . . . is formed by winding the cable 2 in a figure-8 shape to form two circular loops and folding the two loops, as will be described in more detail below. The unit bundles 10A, 10B, 10C, . . . are stacked in the vertical direction (Z direction in the drawing). Further, each of the intermediate parts 40A, 40B, 40C, . . . is the part of the cable 2 that is interposed between the unit bundles 10A, 10B, 10C, . . . . Although FIG. 2 shows only three unit bundles 10A, 10B and 10C on the other end 4 side of the cable 2, the cable bundle 1 actually includes a large number of unit bundles.

The unit bundle 10A includes a first loop 20A and a second loop 30A. Although the first and second loops 20A and 30A have substantially the same diameter in the present embodiment, the diameters of the first and second loops 20A and 30A may be different from each other. The first loop 20A is formed by winding the cable 2 in a “normal winding”. On the other hand, the second loop 30A is formed by winding the cable 2 in a “reverse winding”. The two loops 20A and 30A are stacked such that the second loop 30A is disposed on the first loop 20A in the vertical direction (Z direction in the figure).

Here, in the present embodiment, the “normal winding” is a winding method in which the cable 2 is wound such that the start point of the loop is located (or disposed) on one side (for example, the lower side) with respect to the end point in the stacking direction of the two loops constituting the unit bundle. On the other hand, the “reverse winding” is a winding method in which the cable 2 is wound such that the start point of the loop is located on the other side (for example, the upper side) with respect to the end point in the stacking direction of the two loops.

Therefore, in the first loop 20A of the unit bundle 10A, since the cable 2 is wound such that the start point 21A is located on the lower side with respect to the end point 22A in the stacking direction D₃ (Z direction in the drawing) of the two loops 20A and 30A, the winding method of the first loop 20A is the “normal winding”. On the other hand, in the second loop 30A of the unit bundle 10A, since the cable 2 is wound such that the start point 31A is located on the upper side with respect to the end point 32A in the stacking direction D₃ (Z direction in the drawing) of the two loops 20A and 30A, the winding method of the second loop 30A is the “reverse winding”. The stacking direction D₃ (Z direction in the drawing) of the two loops 20A and 30A corresponds to an example of the “second direction” in the aspect of the present invention.

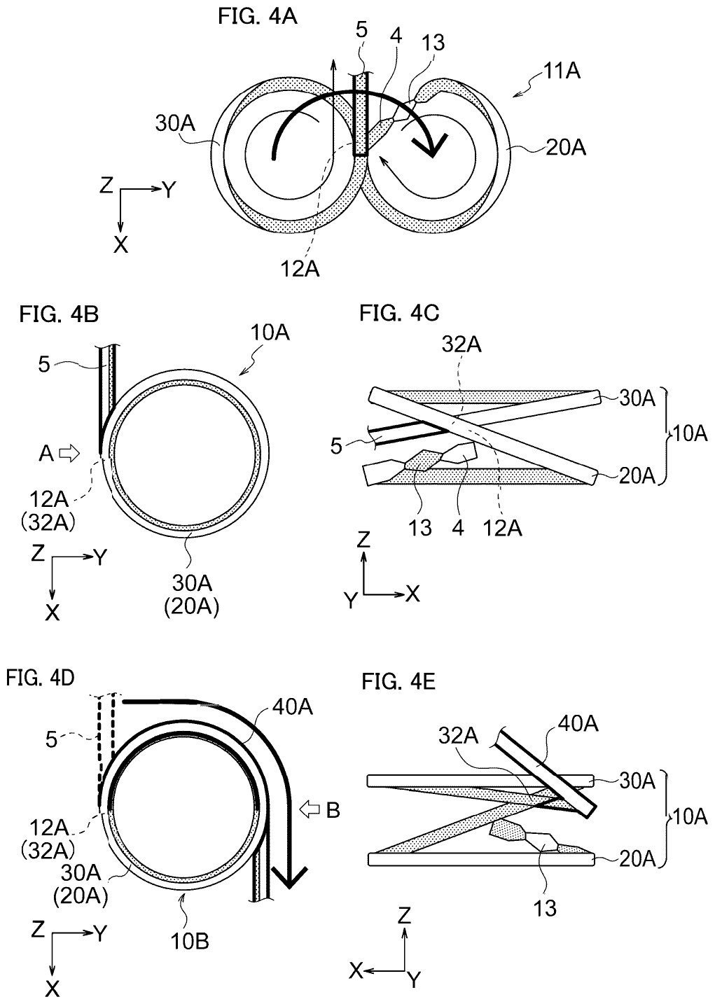

Since the bundle 10A is formed by the figure-8 (figure-eight) winding, the two loops 20A and 30A are connected via the connecting part 12A. In other words, the two loops 20A and 30A are connected to each other via the connecting part 12A such that a figure-8 shaped loop 11A (see FIG. 4A described later) including the first and second loops 20A and 30A is formed when the unit bundle 10A is opened. When the unit bundle 10A is opened (see FIG. 4A), the start point 21A of the first loop 20A is located below the end point 22A of the first loop 20A, and the start point 31A of the second loop 30A is also located below the end point 32A of the second loop 30A. By forming such the figure-8 shaped loop 11A, no twist due to the unit bundle 10A occurs in the cable 2 when the cable 2 is unwound.

Here, the first loop 20A is defined by making the cable 2 cross at the start point 21A and the end point 22A of the first loop 20A, and the second loop 30A is also defined by making the cable 2 cross at the start point 31A and the end point 32A of the second loop 30A. Thus, when the first intersection defining the first loop 20A and the second intersection defining the second loop 30A overlap in the circumferential direction D₁ of the cable bundle 1, the connecting part 12A coincides with the first and second intersections in the circumferential direction D₁. On the other hand, when the first and second intersections are located at different positions in the circumferential direction D₁ of the cable bundle 1, the connecting part 12A is the part of the cable 2 between the first and second intersections including the first and second intersections. Thus, the “figure-8 (figure-eight) shape” in the present embodiment includes the complete figure-8 shape in which the connecting part 12A has no length, and also includes the shape in which the two loops 20A and 20B are connected via the connecting part 12A having a length. The “figure-8 (figure-eight)” in the present embodiment is the Arabic numeral “8”.

The unit bundle 10B includes a first loop 20B formed by winding the cable 2 in the normal winding and a second loop 30B formed by winding the cable 2 in the reverse winding. In the first loop 20B, since the cable 2 is wound such that the start point 21B is located on the lower side with respect to the end point 22B in the stacking direction D₃ (Z direction in the drawing) of the two loops 20B and 30B, the winding method of the first loop 20B is the “normal winding”. On the other hand, in the second loop 30B, since the cable 2 is wound such that the start point 31B is located on the upper side with respect to the end point 32B in the stacking direction D₃ (Z direction in the drawing) of the two loops 20B and 30B, the winding method of the second loop 30B is the “reverse winding”.

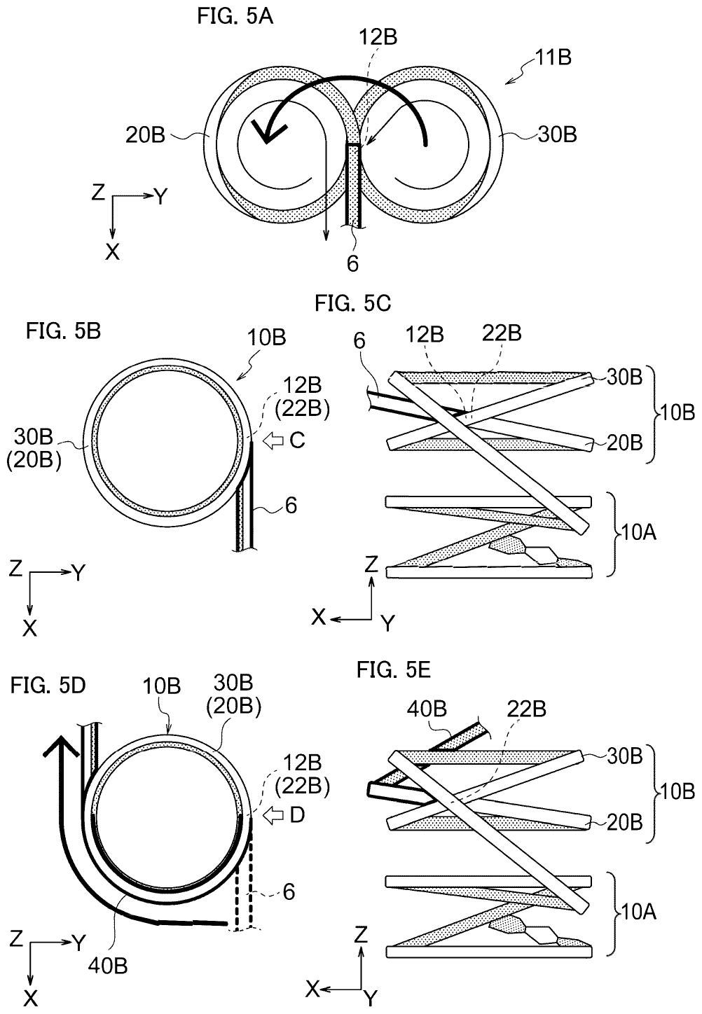

The two loops 20B and 30B are stacked such that the second loop 30B is disposed on the first loop 20B in the vertical direction (Z direction in the drawing). Since the bundle 10B is also formed by the figure-8 (figure-eight) winding, the two loops 20B and 30B are connected via the connecting part 12B. In other words, the two loops 20B and 30B are connected to each other via the connecting part 12B such that a figure-8 shaped loop 11B (see FIG. 5A described later) including the first and second loops 20B and 30B is formed when the unit bundle 10B is opened. When the unit bundle 10B is opened (see FIG. 5A), the start point 21B of the first loop 20B is located below the end point 22B of the first loop 20B, and the start point 31B of the second loop 30B is also located below the end point 32B of the second loop 30B. By forming such the figure-8 shaped loop 11B, no twist due to the unit bundle 10B occurs in the cable 2 when the cable 2 is unwound.

The unit bundle 10B is stacked on the unit bundle 10A. The unit bundles 10A and 10B are connected via the intermediate part 40A of the cable 2. The intermediate part 40A is the part of the cable 2 that is interposed between the unit bundles 10A and 10B, and the intermediate part 40A is wound in the circumferential direction D₁ of the cable bundle 1.

Although not particularly limited, in the present embodiment, as shown in FIG. 3A, the length L₁ of the intermediate part 40A is ½ of the circumferential length L₂ of the second loop 30A of the lower unit bundle 10A to which the intermediate part 40A is connected (L₁=½×L₂), and the connecting part 12A of the unit bundle 10A and the connecting part 12B of the unit bundle 10B are located at different positions by 180 degrees in the circumferential direction D₁ of the cable bundle 1 (θ₁=180°). Therefore, the connecting parts 12A and 12B of the unit bundles 10A and 10B that are adjacent to each other in the stacking direction D₃ (Z direction in the drawing) of the unit bundles are located at different positions in the circumferential direction D₁ of the cable bundle 1. The circumferential direction D₁ of the cable bundle 1 corresponds to an example of the “first direction” in the aspect of the present invention.

The length L₁ of the intermediate part 40A may be ¼ to ¾ of the circumferential length L₂ of the second loop 30A (L₂×¼≤L₁≤L₂×¾). In this case, the connecting part 12A of the unit bundle 10A and the connecting part 12B of the unit bundle 10B are located at different positions within the range of 90 degrees to 270 degrees in the circumferential direction D₁ of the cable bundle 1 (90°≤θ₁≤270°). Alternatively, the length L₁ of the intermediate part 40A may be ⅓ to ⅔ of the circumferential length L₂ of the second loop 30A (L₂×⅓≤L₁≤L₂×⅔). In this case, the connecting part 12A of the unit bundle 10A and the connecting part 12B of the unit bundle 10B are located at different positions within the range of 120 degrees to 240 degrees in the circumferential direction D₁ of the cable bundle 1 (120°≤θ₁≤240°).

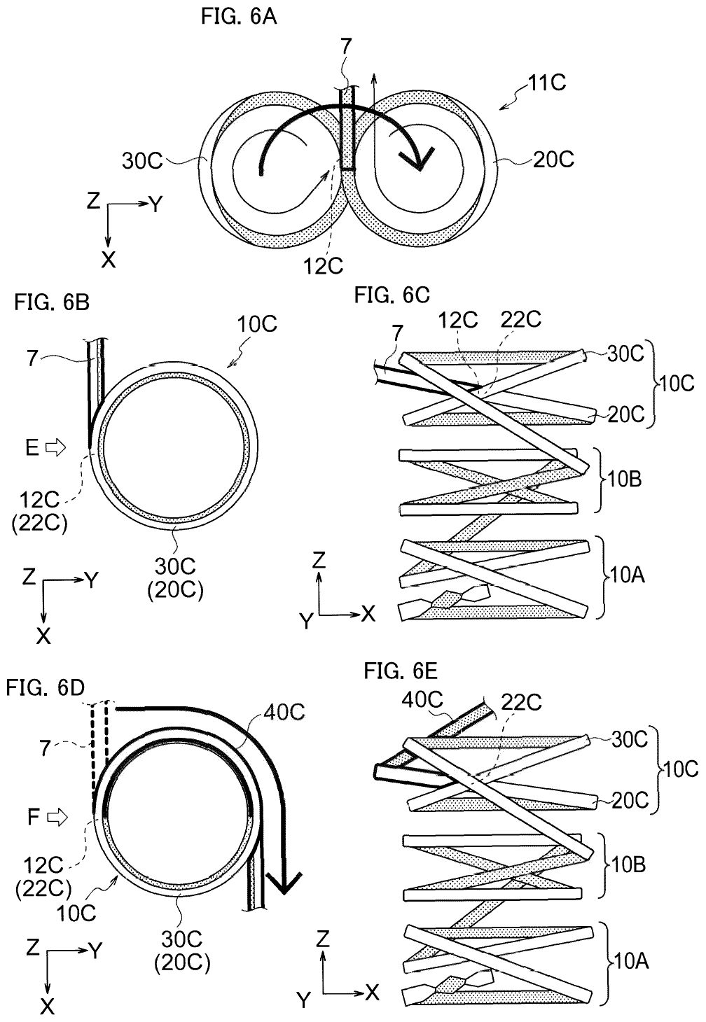

As shown in FIG. 2, the unit bundle 10C also includes a first loop 20C formed by winding the cable 2 in the normal winding and a second loop 30C formed by winding the cable 2 in the reverse winding. The two loops 20C and 30C are stacked such that the second loop 30C is disposed on the first loop 20C in the vertical direction (Z direction in the figure). Since the bundle 10C is also formed by the figure-8 (figure-eight) winding, the two loops 20C and 30C are connected via the connecting part 12C. In other words, the two loops 20C and 30C are connected to each other via the connecting part 12C such that a figure-8 shaped loop 11C (see FIG. 6A described later) including the first and second loops 20C and 30C is formed when the unit bundle 10C is opened. When the unit bundle 10C is opened (see FIG. 6A), the start point 21C of the first loop 20C is located below the end point 22C of the first loop 20C, and the start point 31C of the second loop 30C is also located below the end point 32C of the second loop 30C. By forming such the figure-8 shaped loop 11C, no twist due to the unit bundle 10C occurs in the cable 2 when the cable 2 is unwound.

The unit bundle 10C is stacked on the unit bundle 10B. The unit bundles 10B and 10C are connected via the intermediate part 40B of the cable 2. The intermediate part 40B is the part of the cable 2 that is interposed between the unit bundles 10B and 10C, and the intermediate part 40B is wound in the circumferential D₁ of the cable bundle 1.

Although not particularly limited, in the present embodiment, as shown in FIG. 3B, the length L₃ of the intermediate part 40B is ½ of the circumferential length L₄ of the first loop 20B of the lower unit bundle 10B to which the intermediate part 40B is connected (L₃=½×L₄), and the connecting part 12B of the unit bundle 10B and the connecting part 12C of the unit bundle 10C are located at different positions by 180 degrees in the circumferential direction D₁ of the cable bundle 1 (θ₂=180°). Therefore, the connecting parts 12B and 12C of the unit bundles 10B and 10C that are adjacent to each other in the stacking direction D₃ (Z direction in the drawing) of the unit bundles are located at different positions in the circumferential direction D₁ of the cable bundle 1. Further, the above-described intermediate part 40A and the intermediate part 40B are located at different positions in the circumferential D₁ of the cable bundle 1.

The length L₃ of the intermediate part 40B may be ¼ to ¾ of the circumferential length L₄ of the first loop 20B (L₄×¼≤L₂≤L₄×¾). In this case, the connecting part 12B of the unit bundle 10B and the connecting part 12C of the unit bundle 10C are located at different positions within the range of 90 degrees to 270 degrees in the circumferential direction D₁ of the cable bundle 1 (90°≤θ₂≤270°). Alternatively, the length L₃ of the intermediate part 40B may be ⅓ to ⅔ of the circumferential length L₄ of the first loop 20B (L₄×⅓≤L₃≤L₄×⅔). In this case, the connecting part 12B of the unit bundle 10B and the connecting part 12C of the unit bundle 10C are located at different positions within the range of 120 degrees to 240 degrees in the circumferential direction D₁ of the cable bundle 1 (120°≤θ₂≤240°).

As shown in FIG. 2, in the cable bundle 1 of the present embodiment, the twist 13 is applied to the vicinity of the end part 4 of the unit bundle 10A on the winding start side. The twist 13 is applied to the cable 2 by twisting the cable 2 by one rotation in the direction opposite to a twist caused by the intermediate parts 40A and 40B when the cable 2 is unwound from the cable bundle 1. In other words, the twist 13 is applied to the cable 2 by twisting the cable 2 one rotation in the direction opposite to the winding direction D₂ (refer to FIG. 1) of the cable bundle 1 when viewing the cable bundle 1 from the pull-out side (end part 3 side) of the cable 2. The one rotation twist 13 of the unit bundle 10 can cancel the twist caused by the two intermediate parts 40A and 40B corresponding to one circumference of the cable bundle 1 when the cable 2 is unwound from the cable bundle 1.

Although not particularly shown, the upper unit bundles above the unit bundle 10C of FIG. 2 among the unit bundles are configured by alternately repeating the above-described unit bundle 10B and the unit bundle 10C (hereinafter simply referred to as “unit bundle 10B′” and “unit bundle 10C′”). The unit bundles 10B′ and 10C′ are connected via the above-described intermediate part 40B, and the connection parts 12B and 12C of the unit bundles 10B′ and 10C′ that are adjacent to each other in the stacking direction D₃ (Z direction in the figure) of the unit bundles are located at different positions in the circumferential direction D₁ of the cable bundle 1.

The unit bundle 10C shown in FIG. 2 (or unit bundle 10C′) and the unit bundle 10B′ are connected via the intermediate part 40C. Similar to the above-described intermediate parts 40A and 40B, the intermediate part 40C has a length that is ½ of the circumferential length of the first loop 20C of the lower unit bundle 10C to which the intermediate part 40C is connected. Therefore, the connecting parts 12C and 12B of the unit bundles 10C and 10B′ (or unit bundles 10C′ and 10B′) that are adjacent to each other in the stacking direction D₃ (Z direction in the figure) of the unit bundles are also located at different positions in the circumferential direction D₁ of the cable bundle 1.

Further, in the upper unit bundles above the unit bundle 10C of FIG. 2 among the unit bundles, one rotation of twist 13 is applied to the two unit bundles 10B′ and 10C′.

The position where the twist 13 is applied in the cable bundle 1 is not limited to the vicinity of the end part of the unit bundle. For example, the twist 13 may be applied to any position in the unit bundle, or the twist 13 may be applied to the intermediate part connecting the unit bundles. At this time, the total rotation number R of all the twists 13 applied to the entire cable bundle 1 is preferably equal to or less than the value obtained by dividing the total Lₜ of the lengths of all the intermediate parts 40A, 40B, . . . of the cable bundle 1 by the average circumferential length L₀ of the cable bundle 1 (R≤Lₜ/L₀), and the rotation number R is more preferably equal to the value obtained by dividing the total Lₜ of the lengths of the intermediate parts 40A, 40B, . . . by the average circumferential length L₀ of the cable bundle 1 (R=Lₜ/L₀). Thereby, the twist caused by the intermediate parts 40A, 40B, . . . of the cable bundle 1 can be canceled. The average circumferential length L₀ of the cable bundle 1 is a value obtained by dividing the total length of the cable 2 by the winding number of the cable 2.

Hereinafter, the method of manufacturing the above-described cable bundle 1 will be described with reference to FIG. 4A to FIG. 6E. FIG. 4A to FIG. 4E are diagrams illustrating the method of forming the first unit bundle 10A of the cable bundle 1 in the first embodiment of the present invention, FIG. 5A to FIG. 5E are diagrams illustrating the method of forming the second unit bundle 10B of the cable bundle 1 in the first embodiment of the present invention, and FIG. 6A to FIG. 6E are diagrams illustrating the method of forming the third unit bundle 10C of the cable bundle 1 in the first embodiment of the present invention.

FIG. 4C is the diagram of the unit bundle 10A viewed from the direction A in FIG. 4B, and FIG. 4E is the diagram of the unit bundle 10A viewed from the direction B in FIG. 4D. Similarly, FIG. 5C is the diagram of the unit bundle 10B viewed from the direction C in FIG. 5B, and FIG. 5E is the diagram of the unit bundle 10B viewed from the direction D in FIG. 5D. Similarly, FIG. 6C is the diagram of the unit bundle 10C viewed from the direction E in FIG. 6B, and FIG. 6E is the diagram of the unit bundle 10C viewed from the direction F in FIG. 6D.

First, as shown in FIG. 4A), the figure-8 shaped loop 11A is formed by disposing the cable 2 in the figure-8 shape. The third loop 11A includes the first and second loops 20A and 30A connected via the connecting part 12A. At this time, in the first loop 20A, the winding method of the first loop 20A is set to the “normal winding” by winding the cable 2 such that the start point 21A is located on the lower side with respect to the end point 22A. On the other hand, even in the second loop 30A, the cable 2 is wound such that the start point 31A is located on the lower side with respect to the end point 32A. When the second loop 30A is reversed thereafter, the winding method of the second loop 30A becomes the “reverse winding”.

Further, when the cable 2 is disposed in the figure-8 shape, the twist 13 is formed in the vicinity of the end part 4 of the cable 2 in the first loop 20A. The twist 13 is applied to the cable 2 by twisting the cable 2 one rotation in the direction opposite to the winding direction D₂ (refer to FIG. 1) of the cable bundle 1 when viewing the cable bundle 1 from the pull-out side (end part 3 side) of the cable 2. For example, in the example shown in FIG. 1, when the cable bundle 1 is viewed from the pull-out side (end part 3 side) of the cable 2, since the winding direction D₂ of the cable bundle 1 is clockwise, the twist 13 that is counterclockwise is applied to the cable 2.

Next, as shown in FIG. 4B and FIG. 4C, the figure-8 shaped third loop 11A is folded at the connecting part 12A, and the second loop 30A is stacked on the first loop 20A to form the unit bundle 10A.

Next, as shown in FIG. 4D and FIG. 4E, the part 5 of the cable 2 (part 5 on the end part 3 side from the end point 32A of the second loop 30A in the cable 2) is wound by 180 degrees in the circumferential direction D₁ of the cable bundle 1. The part 5 of the cable 2 corresponds to the intermediate part 40A between the unit bundles 10A and 10B.

Next, as shown in FIG. 5A, the figure-8 shaped third loop 11B is formed by disposing the part of the cable 2 following the part 5 in the figure-8 shape. The third loop 11B includes the first and second loops 20B and 30B connected via the connecting part 12B. At this time, in the first loop 20B, the winding method of the first loop 20B is set to the “normal winding” by winding the cable 2 such that the start point 21B is located on the lower side with respect to the end point 22B. On the other hand, even in the second loop 30B, the cable 2 is wound such that the start point 31B is located on the lower side with respect to the end point 32B. When the second loop 30B is reversed thereafter, the winding method of the second loop 30B becomes the “reverse winding”. The twist 13 is not applied to the third loop 11B.

In the third loop 11B of the second stage, the first loop 20B and the second loop 30B are reverse compared to the positional relation of the first and second loops 20A and 30A in the third loop 11A of the first stage. That is, in the third loop 11A of the first stage shown in FIG. 4A, the first loop 20A is located on the right side with respect to the second loop 30A, whereas in the third loop 11B of the second stage shown in FIG. 5A, the first loop 20B is located on the left side with respect to the second loop 30B.

Next, as shown in FIG. 5B and FIG. 5C, the figure-8 shaped third loop 11B is folded at the connecting part 12B, and the second loop 30B is stacked on the first loop 20B to form the unit bundle 10B.

Next, as shown in FIG. 5D and FIG. 5E, the part 6 of the cable 2 (part 6 on the end part 3 side from the end point 22B of the first loop 20B in the cable 2) is wound by 180 degrees in the circumferential direction D₁ of the cable bundle 1. The part 6 of the cable 2 corresponds to the intermediate part 40B between the unit bundles 10B and 10C.

Next, as shown in FIG. 6A, the figure-8 shaped third loop 11C is formed by disposing the part of the cable 2 following the part 6 in the figure-8 shape. The third loop 11C includes the first and second loops 20C and 30C connected via the connecting part 12C. At this time, in the first loop 20C, the winding method of the first loop 20C is set to the “normal winding” by winding the cable 2 such that the start point 21C is located on the lower side with respect to the end point 22C. On the other hand, even in the second loop 30C, the cable 2 is wound such that the start point 31C is located on the lower side with respect to the end point 32C. When the second loop 30C is reversed thereafter, the winding method of the second loop 30C becomes the “reverse winding”. The twist 13 is also not applied to the third loop 11C.

In the third loop 11B of the second stage, the first loop 20C and the second loop 30C are reverse compared to the positional relation of the first and second loops 20B and 30B in the above-described third loop 11B of the second stage. That is, in the third loop 11B of the second stage shown in FIG. 5A, the first loop 20B is located on the left side with respect to the second loop 30B, whereas in the third loop 11C of the third stage shown in FIG. 6A, the first loop 20C is located on the right side with respect to the second loop 30C.

Next, as shown in FIG. 6B and FIG. 6C, the figure-8 shaped third loop 11C is folded at the connecting part 12C, and the second loop 30C is stacked on the first loop 20C to form the unit bundle 10C.

Next, as shown in FIG. 6D and FIG. 6E, the part 7 of the cable 2 (part 7 on the end part 3 side from the end point 22C of the first loop 20C in the cable 2) is wound by 180 degrees in the circumferential direction D₁ of the cable bundle 1. The part 7 of the cable 2 corresponds to the intermediate part 40C between the unit bundle 10C and the next unit bundle (above-described unit bundle 10B′).

Thereafter, the cable bundle 1 is formed by alternately forming the unit bundle and the intermediate part in the same manner as described above. As described above, the upper unit bundles above the unit bundle 10C of FIG. 2 among the unit bundles are configured by alternately repeating the unit bundle 10B′ and unit bundle 10C′. The unit bundle 10B′ and the unit bundle 10C′ are connected via the above-described intermediate part 40B of the cable 2. Further, the unit bundle 10C′ and the unit bundle 10B′ are connected via the above-described intermediate part 40C.

In the above-described manufacturing method, although forming and stacking unit bundles are repeated in order from the bottom, the manufacturing method is not particularly limited to this. For example, all of the unit bundles may be stacked after forming all of the unit bundles. Alternatively, all of the unit bundles may be formed by folding the third loops after forming all of the third loops, and then all of the unit bundles may be stacked. Alternatively, the unit bundle may be formed without undergoing the open state in the figure-8 shape.

As described above, in the present embodiment, the connecting parts (for example, the connecting parts 12A and 12B) of the unit bundles (for example, the unit bundles 10A and 10B) adjacent to each other in the stacking direction D₃ (Z direction in the drawing) of the unit bundles 10A, 10B, 10C, . . . are located at different positions in the circumferential direction D₁ of the cable bundle 1. For this reason, since the upper unit bundle (for example, the unit bundle 10B) functions as a weight for the loops of the lower unit bundle (for example, the loops 20A and 30A of the unit bundle 10A), it is possible to suppress the lifting of the loops (for example, the loops 20A and 30A of the unit bundle 10A) being to be unwound later and to prevent the cable 2 from being tangled.

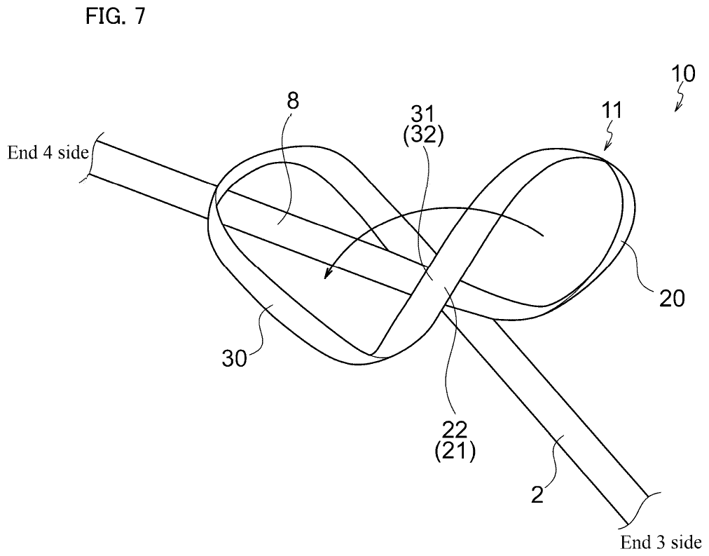

The configuration of the figure-8 shaped loop when the unit bundle is opened is not limited to the above-described configuration as long as no twist due to the unit bundle occurs in the cable when the cable is unwound. For example, it may be the figure-8 shaped loop 11 having the configuration as shown in FIG. 7. FIG. 7 is a perspective view showing the configuration of the figure-8 shaped loop 11 when the unit bundle 10 is opened in the second embodiment of the present invention.

In the example shown in FIG. 7, when the unit bundle 10 is opened, the start point 21 of the first loop 20 is located on the lower side with respect to the end point 22 of the first loop 20. Further, in the example shown in FIG. 7, when the unit bundle 10 is opened, the end point 32 of the second loop 30 is located on the lower side with respect to the start point 31 of the second loop 30 and the start point 21 of the first loop 20, and the part 8 of the cable 2 (part 8 on the end part 4 side from the start point 21 of the first loop 20 in the cable 2) passes through the second loop 30. By forming such the figure-8 shaped loop 11, no twist due to the unit bundle 10 occurs in the cable 2 when the cable 2 is unwound.

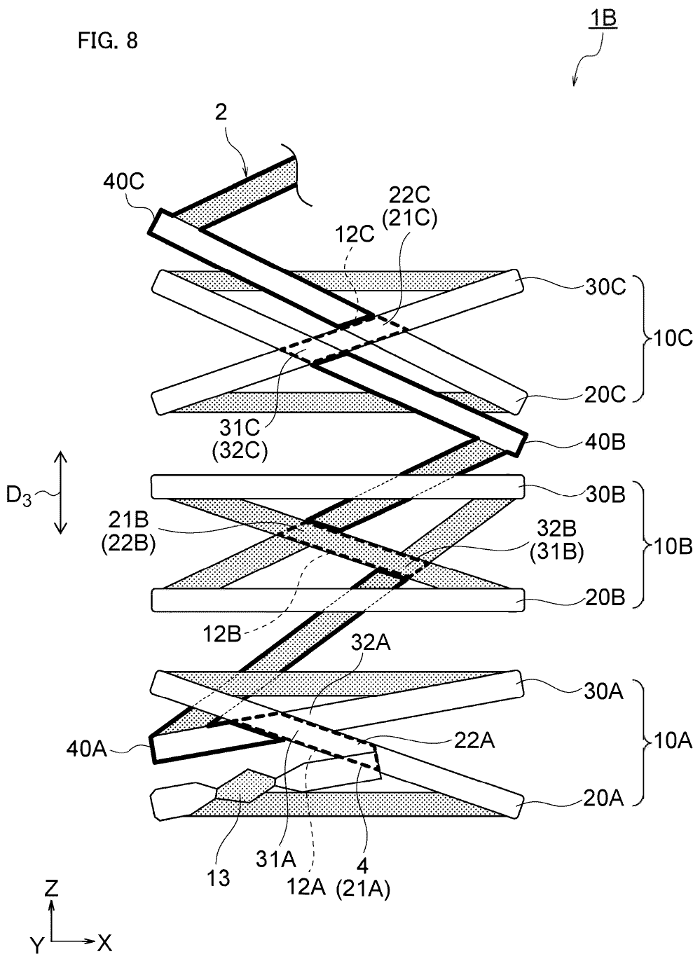

When the unit bundle 10 shown in FIG. 7 is used as unit bundles 10B and 10C, a cable bundle 1B shown in FIG. 8 is formed. Regarding the unit bundle 10B of the cable bundle 1B shown in FIG. 8, in the first loop 20B, since the cable 2 is wound such that the start point 21B is located on the upper side with respect to the end point 22B in the stacking direction D₃ (Z direction in the drawing) of the two loops 20B and 30B, the winding method of the first loop 20B is the “reverse winding”. On the other hand, in the second loop 30B as well, since the cable 2 is wound such that the start point 31B is located on the upper side with respect to the end point 32B in the stacking direction D₃ (Z direction in the drawing) of the two loops 20B and 30B, the winding method of the second loop 30B is the “reverse winding”. That is, the winding method of both of the first and second loops 20B and 30B is the “reverse winding”. Similarly, regarding the unit bundle 10C of the cable bundle 1B shown in FIG. 8, the winding method of both of the first and second loops 20C and 30C is the “reverse winding”.

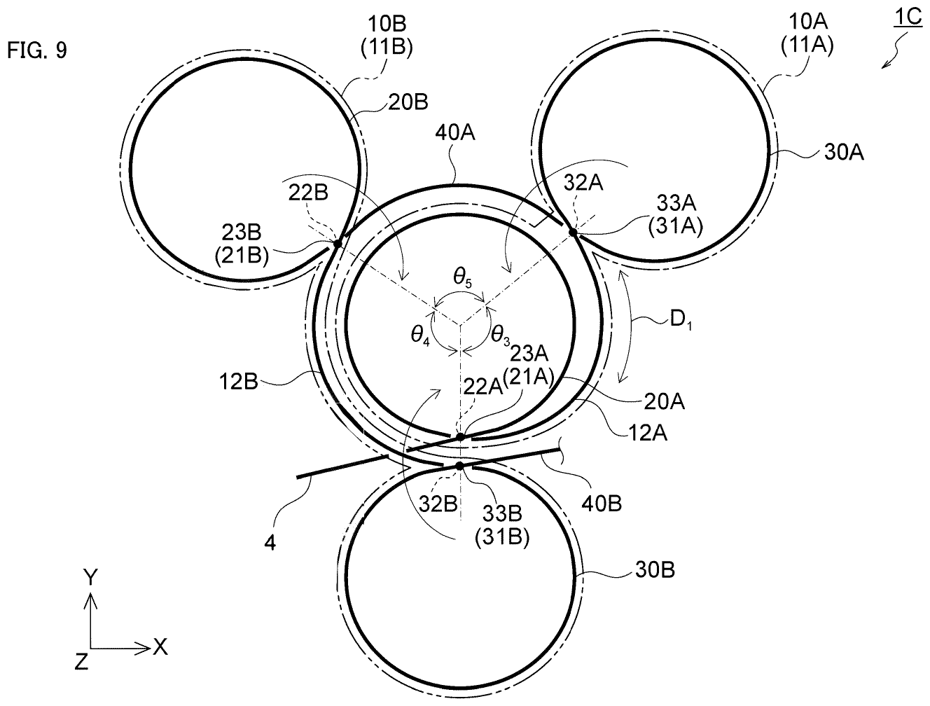

As described above, the connecting part of the unit bundle may have a length. A cable-bundle 1C in the third embodiment of the present invention will be described with reference to FIG. 9. FIG. 9 is a developed view of a part of a cable bundle 1C in the third embodiment of the present invention.

As shown in FIG. 9, the cable bundle 1C includes unit bundles 10A, 10B, . . . and intermediate parts 40A, 40B, . . . . As described later, in the present embodiment, the cable bundle 1C is formed by twisting the cable 2 to from the individual loops in order and stacking the loops in order. Although FIG. 9 shows only two unit bundles 10A and 10B on the end part 4 side of the cable 2, the cable bundle 1C actually includes a large number of unit bundles. Further, although FIG. 9 shows a state in which the unit bundles 10A and 10B are opened because FIG. 9 is a developed view of the cable bundle 1C, the unit bundles 10A, 10B, . . . are actually stacked in the vertical direction (Z direction in the drawing).

The unit bundle 10A includes a first loop 20A and a second loop 30A. Since the first loop 20A is formed by winding the cable 2 such that the start point 21A is located on the upper side with respect to the end point 22A, the winding method of the first loop 20A is the “reverse winding”. On the other hand, since the second loop 30A is formed by winding the cable 2 such that the start point 31A is located on the lower side with respect to the end point 32A, the winding method of the second loop 30A is the “normal winding”. Since FIG. 9 shows the cable bundle 1C in an open state, the start point 31A of the second loop 30A is located on the upper side with respect to the end point 32A. The two loops 20A and 30A are stacked such that the second loop 30A is disposed on the first loop 20A in the vertical direction (Z direction in the drawing). The two loops 20A and 30A are connected to each other via the connecting part 12A such that a figure-8 shaped loop 11A including the first and second loops 20A and 30A is formed when the unit bundle 10A is opened.

In the present embodiment, the intersection 23A of the first loop 20A (the point where the start point 21A and the end point 22A intersect) does not coincide with the intersection 33A of the second loop 30A (the point where the start point 31A and the end point 32A intersect), and the intersection 33A of the second loop 30A is separated from the intersection 23A of the first loop 20A. As described above, since the connecting part 12A of the unit bundle 10A is the part of the cable 2 between the intersections 23A and 33A of the first and second loops 20A and 30A, the connection part 12A of the present embodiment has a predetermined length. The connecting part 12A is wound in the circumferential direction D₁ of the cable bundle 1C. The length of the connecting part 12A has a length corresponding to the center angle θ₃ in the circumferential direction D₁ of the cable bundle 1C. Although not particularly limited, an example of the center angle θ₃ is, for example, 120° (θ₃=120°). The central angle defining the length of the connecting part is preferably 120° or less.

The unit bundle 10B includes a first loop 20B and a second loop 30B. Since the first loop 20B is formed by winding the cable 2 such that the start point 21B is located on the upper side with respect to the end point 22B, the winding method of the first loop 20B is the “reverse winding”. Since the second loop 30B is also formed by winding the cable 2 such that the start point 31B is located on the upper side with respect to the end point 32B, the winding method of the second loop 30B is also the “reverse winding”. Since FIG. 9 shows the cable bundle 1C in an open state, the start point 21B of the first loop 20B is located on the lower side with respect to the end point 22B, and the start point 31B of the second loop 30B is also located on the lower side with respect to the end point 32B.

The two loops 20B and 30B are stacked such that the second loop 30B is disposed on the first loop 20B in the vertical direction (Z direction in the drawing). The two loops 20B and 30B are connected to each other via the connecting part 12B such that a figure-8 shaped loop 11B including the first and second loops 20B and 30B is formed when the unit bundle 10B is opened. The winding method of the second loop 30B may be the “normal winding”.

In the present embodiment, the intersection 23B of the first loop 20B (the point where the start point 21B and the end point 22B intersect) does not coincide with the intersection 33B of the second loop 30B (the point where the start point 31B and the end point 32B intersect), and the intersection 33B of the second loop 30B is separated from the intersection 23B of the first loop 20B. As described above, since the connecting part 12B of the unit bundle 10B is the part of the cable 2 between the intersections 23B and 33B of the first and second loops 20B and 30B, the connection part 12B of the present embodiment has a predetermined length. The connecting part 12B is wound in the circumferential direction D₁ of the cable bundle 1C. The length of the connecting part 12B has a length corresponding to the center angle θ₄ in the circumferential direction D₁ of the cable bundle 1C. Although not particularly limited, an example of the center angle θ₄ is, for example, 120° (θ₄=120°).

The unit bundle 10B is stacked on the unit bundle 10A. At this time, the start point 31B and the end point 32B of the second loop 30B of the unit bundle 10B are located above the start point 21A and the end point 22A of the first loop 20A of the unit bundle 10A. The unit bundles 10A and 10B are connected via the intermediate part 40A of the cable 2. The intermediate part 40A is the part of the cable 2 that is interposed between the end point 32B of the second loop 30A of the unit bundle 10A and the start point 21B of the first loop 20B of the unit bundle 10B, and the intermediate part 40A is wound in the circumferential direction D₁ of the cable bundle 1C. The length of the intermediate part 40A has a length corresponding to the center angle θ₅ in the circumferential direction D₁ of the cable bundle 1C. Although not particularly limited, an example of the center angle θ₅ is, for example, 120° (θ₅=120°).

In the present embodiment, since each of the connecting parts 12A and 12B of the unit bundles 10A and 10B and the intermediate part 40A has a length corresponding to 120° in the circumferential direction D₁ of the cable bundle 1C, these sum forms a loop of one circumference in the circumferential direction D₁ of the cable bundle 1C. Whereas the winding method of the loop formed by the connecting parts 12A and 12B and the intermediate part 40A and the winding method of the second loop 30B of the unit bundle 10A are the “normal winding”, the winding method of the first loop 20A of the unit bundle 10A and the winding method of the first loop 20B of the unit bundle 10B are the “reverse winding”, and the number of the loops of the “normal winding” and the number of the loops of the “reverse winding” are the same. Therefore, since there is no twist in these four loops, there is no need to form the twist 13 described in the first embodiment in the cable bundle 1C.

In the above-described relationship in which the twist is zero, the total number of the first and second loops connected with the connecting part and the intermediate part is not particularly limited to the above as long as it is an odd number. In the above relationship in which the twist is zero, the winding method of each loop is not particularly limited to the above as long as the number of the loops of the “normal winding” and the number of the loops of the “reverse winding” are the same. The lengths of the connecting parts and the intermediate part forming the loop of one circumference in the circumferential direction D₁ of the cable bundle 1C may not be equal.

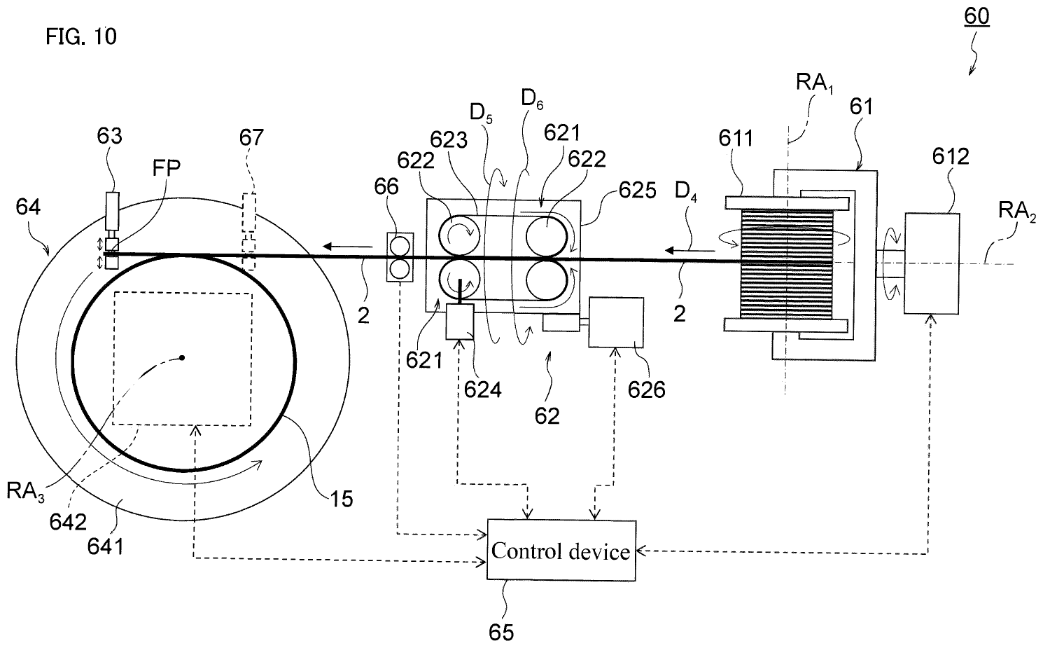

Next, the configuration of the manufacturing apparatus 60 for manufacturing the above-mentioned cable bundle 1C will be described with reference to FIG. 10. FIG. 10 is a diagram illustrating the cable bundle manufacturing apparatus 60 in the third embodiment of the present invention.

As shown in FIG. 10, the manufacturing apparatus 60 of the present embodiment includes a holding device 61, a twisting device (or twister) 62, a fixing device (or fixer) 63, a rotating device (or rotator) 64, and a control device 65.

The holding device 61 holds a drum 611 around which the cable 2 is wound. The drum 611 is rotatably held by the holding device 61 about the central axial RA₁ of the drum 611. In the present embodiment, although the drum 611 is passively rotated as the cable 2 is pulled out by the caterpillar 621 of the twisting device 62, the holding device 61 may include a driving device that rotationally drives the drum 611 about the rotational axis RA₁ of the drum 611. In this case, the driving device works in conjunction with the caterpillar 621 of the twisting device 62 to positively convey the cable 2 from the drum 611.

The holding device 61 may include a rotating device (or rotator) 612 that rotates the drum 611 about the rotational axis RA₂ substantially parallel to the direction D₄ in which the cable 2 is conveyed from the drum 611. Thus, when a twist occurs in the part of the cable 2 between the drum 611 and the twisting device 62, it is possible to easily remove the twist from the cable 2. The rotational axis RA₂ is also an axis substantially perpendicular to the rotational axis RA₁ of the drum 611. The rotational axis RA₂ corresponds to an example of the “second axis” in the aspect of the present invention.

The twisting device 62 includes a pair of caterpillars 621, a frame 625, and a rotating device (or rotator) 626. Each of the caterpillars 621 includes a pair of pulleys 622, an endless belt 623 which is wound around the pulleys 622, and a driving device 624 that rotates the pulley 622. The pair of caterpillars 621 are arranged such that the belts 623 are in close contact with each other, and the cable 2 supplied from the drum 611 can be sandwiched between the belts 623. The driving device 624 includes a motor, a gearbox and the like that rotate the pulley 622, and the cable 2 can be pulled out from the drum 611 and the cable 2 can be pushed out from the twisting device 62 by driving the caterpillar 621. The pair of caterpillars 621 corresponds to an example of the “sending device” or “conveyor” in aspects of the present invention.

The pair of caterpillars 621 is housed in the frame 625. The rotating device 626 includes a motor, a gearbox and the like that rotate the frame 625. The rotating device 626 is capable of twisting the cable 2 held between the pair of caterpillars 621 by rotating the frame 625 around the axial direction of the cable 2. The rotating device 626 is capable of rotating the frame 625 by 360° in one rotational direction D₅ and is capable of rotating the frame 625 by 360° in the other rotational direction D₆. The one rotational direction D₅ corresponds to an example of the “third direction” in the aspect of the present invention, and the other rotational direction D₆ corresponds to an example of the “fourth direction” in the aspect of the present invention.

The configuration of the twisting device 62 is not particularly limited to the above as long as it includes a function of conveying the cable 2 and a function of twisting the cable 2. Although not particularly shown, for example, the twisting device 62 may include a gripping part that grips the cable and a moving part that moves the gripping part in the axial direction of the cable 2, and the gripping part may include rollers capable of twisting the cable. Although not particularly shown, the function of conveying the cable 2 and the function of twisting the cable 2 may be realized by mutually independent devices.

The fixing device 63 is a device that fixes the cable 2 sent out from the twisting device 62. Although not particularly limited, a specific example of the fixing device 63 is a clamp that pinches and fixes the fixed position FP of the cable 2 by using an air cylinder or the like. The fixing device 63 fixes the movement of the cable 2 in the axial direction at the fixed position FP on the cable 2. The fixed position FP is the position on the cable 2 that is separated from the twisting device 62 by a predetermined distance. This predetermined distance is a distance that allows one loop 15 (for example, the first loop 20A) of the cable 2 to be formed between the fixed position FP and the twisting device 62.

When the cable 2 is conveyed toward the fixed position FP by the caterpillars 621 of the twisting device 62 and the rotating device 626 of the twisting device 62 rotates in one rotational direction D₅ in a state where the fixing device 63 fixes the fixing position FP on the cable, the “reverse winding” loop is formed. On the other hand, when the pair of caterpillars 621 rotate the frame 625 in the other rotational D₆, the “normal winding” loop is formed.

The rotating device 64 includes a placement table 641 and a driving device 642. The loops 15 formed by the twisting device 62 are placed on the placement table 641 and stacked. The placement table 641 includes a placement surface on which the loops 15 of the cable 2 are placed. The driving device 642 includes a motor, a gear box and the like that rotate the placement surface of the placement table 641. The driving device is capable of rotating the placement surface of the placement table 641 about a rotational axis RA₃ substantially parallel to the normal direction of the placement table 641. The rotational axis RA₃ corresponds to an example of the “first axis” in the aspect of the present embodiment. In the example shown in FIG. 10, although the driving device 642 rotates the placement surface of the placement table 641 only counterclockwise, the driving device 642 may rotate the placement surface of the placement table 641 in both clockwise and counterclockwise directions.

The control device 65 includes, for example, a computer. Although not particularly shown, the computer is an electronic computer including a CPU (processor), a main storage device (such as a RAM), a secondary storage device (such as a hard disk and a SSD), interfaces, and the like. The control device 65 is controllably connected to the driving device 624 and the rotating device 626 of the twisting device 62, the fixing device 63, and the driving device 642 of the rotating device 64. These controls are functionally realized, for example, by the control device 65 executing a program. The control device 65 may be configured with a circuit board instead of the computer.

Next, a manufacturing process for manufacturing the cable bundle 1C shown in FIG. 9 using the manufacturing device 60 described above will be described.

First, in a state where the cable 2 is pulled out from the twisting device 62 to the fixing device 63, the control device 65 transmits a control signal to the fixing device 63, and the fixing device 63 pinches the fixed position FP on the cable 2. Therefore, the movement of the cable 2 in the axial direction at the fixed position FP on the cable 2 is fixed by the fixing device 63.

Next, the control device 65 transmits a control signal to the driving device 624 of the twisting device 62, and the caterpillars 621 convey the cable 2 from the twisting device 62 by a predetermined amount. This predetermined amount is a length corresponding to one loop 15 of the cable 2 and is a value input to the control device 65 in advance.

Next, the control device 65 sends a control signal to the rotating device 626 of the twisting device 62, and the rotating device 626 rotates the frame 625 by 360° in one rotational direction D₅ to twist the cable 2, therefore the first loop 20A of the “reverse winding” is formed. The first loop 20A is placed on the placement table 641 of the rotating device 64. The twisting device 62 may twist the cable 2 while conveying a predetermined amount of the cable 2.

Next, the control device 65 transmits a control signal to the fixing device 63, and the fixing device 63 loosens the fixing of the cable 2 to release the cable 2. Next, the control device 65 transmits control signals to the driving device 642 of the rotating device 64 and the driving device 624 of the twisting device 62. As a result, the driving device 642 rotates the placement surface of the placement table 641 by the center angle θ₃, and simultaneously, the caterpillars 621 conveys the cable 2 from the twisting device 62 by a predetermined amount. This predetermined amount is a length corresponding to the center angle θ₃ in the circumferential direction D₁ of the cable bundle 1C and is a value input to the control device 65 in advance. Although not particularly limited, in the present embodiment, the center angle θ₃ is 120° (θ₃=120°). As a result, the connecting part 12A of the unit bundle 10A in the cable bundle 1C is formed.

Next, the second loop 30A of the unit bundle 10A is formed in the same manner as the first loop 20A described above. At this time, the rotating device 626 rotates the frame 625 by 360° in other rotational direction D₆ to twist the cable 2, therefore the second loop 30A of the “normal winding” is formed. The second loop 30A is placed on the placement table 641 of the rotating device 64 to form the unit bundle 10A. The twisting device 62 may twist the cable 2 while conveying a predetermined amount of the cable 2.

Next, the control device 65 transmits a control signal to the fixing device 63, and the fixing device 63 loosens the fixing of the cable 2 to release the cable 2. Next, the control device 65 transmits control signals to the driving device 642 of the rotating device 64 and the driving device 624 of the twisting device 62. As a result, the driving device 642 rotates the placement surface of the placement table 641 by the center angle θ₄, and simultaneously, the caterpillars 621 conveys the cable 2 from the twisting device 62 by a predetermined amount. This predetermined amount is a length corresponding to the center angle θ₄ in the circumferential direction D₁ of the cable bundle 1C and is a value input to the control device 65 in advance. Although not particularly limited, in the present embodiment, the center angle θ₄ is 120° (θ₄=120°). As a result, the intermediate part 40A between the unit bundles 10A and 10B in the cable bundle 1C is formed.

Thereafter, the cable bundle 1C is formed by alternately forming the unit bundle and the intermediate part in the same manner as described above. If a twist occurs in the part of the cable 2 between the drum 611 and the twisting device 62, it is possible to remove the twist by rotating the drum 611 using the above-described rotating device 612.

As described above, in the manufacturing apparatus 60 of the present embodiment, since the driving device 642 of the rotating device 64 rotates the placement surface of the placement table 641 on which the loops 15 of the cable 2 are placed, it is possible to manufacture the cable bundle 1C that includes the connecting parts 12A and 12B located at different positions in the circumferential direction D₁.

The manufacturing apparatus 60 may include a measuring device 66 that measures the length of the cable 2 sent out by the twisting device 62. In this case, the control device 65 may control the driving device 624 of the twisting device 62 such that the caterpillars 621 convey the cable 2 from the twisting device 62 by a predetermined amount based on the measurement result of the measuring device 66. Although not particularly limited, an encoder can be exemplified as a specific example of the measurement device 66. Alternatively, the length of the cable 2 sent out from the twisting device 62 may be measured by the measuring device 66 to perform quality control of the cable bundle 1.

The cable bundle 1 shown in FIG. 1 may be manufactured using the manufacturing apparatus 60 described above. In this case, as shown in FIG. 10, the manufacturing apparatus 60 includes an additional fixing device 67 in addition to the above-described fixing device 63. The additional fixing device 67 has a configuration similar to that of the fixing device 63 described above. When forming each unit bundle, the fixing device 63 is used to form the first loop, and the additional fixing device 67 is used to form the second loop.

It should be noted that the embodiments described above are described to facilitate understanding of the present disclosure and are not described to limit the present disclosure. It is therefore intended that the elements disclosed in the above embodiments include all design modifications and equivalents to fall within the technical scope of the present disclosure.

For example, although the cable bundle 1 has the drumless structure that does not have a winding core in the above-described embodiments, the cable bundle 1 is not particularly limited to this. The cable bundle 1 may have a winding core, or the cable bundle 1 may be formed around the guide pin for drawing out.

In the above-described embodiments, although the unit bundles 10A, 10B, 10C, . . . are stacked in a direction (the stacking direction D₃ of the unit bundles (Z direction in the drawing)) perpendicular to the radial direction, it is not limited to this. For example, the unit bundles having different diameters disposed on the same plane may be stacked in the stacking direction D₃ by appropriately changing the size of the diameters of the loop included in the unit bundle. Alternatively, other unit bundles each of which has a diameter larger than the diameter of the unit bundle may be stacked in the stacking direction D₃ on the outer side of the unit bundles stacked in the stacking direction D₃ by appropriately changing the size of the diameters of the loop included in the unit bundle.

The connecting parts of the unit bundles may be located at different positions in the circumferential direction D₁ of the cable bundle 1 by making the diameters of the unit bundles adjacent to the stacking direction D₃ of the unit bundles different. The first intersection and the second intersection may be located at different positions in the circumferential direction D₁ of the cable bundle 1 by making the diameters of the first and second loops of the unit bundle different.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATIONS OF LETTERS OR NUMERALS

1, 1B, 1C . . . Cable bundle
2 . . . Cable
3, 4 . . . End
10A, 10B, 10C . . . Unit bundle
11A, 11B, 11C . . . Figure-8 shaped loop
12A, 12B, 12C . . . Connecting part
13 . . . Twist
20A, 20B, 20C . . . First loop
21A, 21B, 21C . . . Start point
22A, 22B, 22C . . . End point
23A, 23B . . . Intersection
30A, 30B, 30C . . . Second loop
31A, 31B, 31C . . . Start point
32A, 32B, 32C . . . End point
33A, 33B . . . Intersection
40A, 40B . . . Intermediate part
50 . . . Container
51 . . . Upper surface
52 . . . Opening
60 . . . Manufacturing apparatus
61 . . . Holding device
611 . . . Drum
612 . . . Rotating device
62 . . . Twisting device
621 . . . Caterpillar
622 . . . Pulley
623 . . . Belt
624 . . . Driving device
625 . . . Frame
626 . . . Rotating device
63 . . . Fixing device
64 . . . Rotating device
641 . . . Placement table
642 . . . Driving device
65 . . . Control device
66 . . . Measuring device
67 . . . Fixing device

1. A cable bundle comprising:
a cable that is wound;
unit bundles stacked in a stacking direction perpendicular to a first direction that is a circumferential direction of the cable bundle;
connecting parts, wherein
each of the unit bundles comprises a first loop and a second loop that are stacked in the stacking direction,
the first loop and the second loop are connected via a respective one of the connecting parts such that a figure-8 shaped loop including the first loop and the second loop is formed in a state in which each of the unit bundles is opened, and
the connecting parts of adjacent ones of the unit bundles in the stacking direction are disposed at different positions in the first direction.

2. The cable bundle according to claim 1, further comprising:
an intermediate part that:
is interposed between the unit bundles and connects the unit bundles to each other, and
is wound in the first direction such that the connecting parts of adjacent ones of the unit bundles in the stacking direction are disposed at different positions within a range of 90 degrees to 270 degrees in the first direction.

3. The cable bundle according to claim 1, wherein
the unit bundles include:
a first unit bundle;
a second unit bundle stacked on the first unit bundle; and
a third unit bundle stacked on the second unit bundle,
the cable bundle further comprises:
a first intermediate part that is interposed between the first unit bundle and the second unit bundle and connects the first unit bundle and the second unit bundle to each other; and
a second intermediate part that is interposed between the second unit bundle and the third unit bundle and connects the second unit bundle and the third unit bundle to each other,
the first intermediate part and the second intermediate part are wound in the first direction, and
the first intermediate part and the second intermediate part are disposed at different positions in the first direction.

4. The cable bundle according to claim 1, further comprising:
an intermediate part that:
is interposed between the unit bundles,
connects the unit bundles to each other, and
is wound in the first direction, wherein
the cable has an opposite twist opposite to a twist caused by the intermediate part when the cable is unwound.

5. The cable bundle according to claim 4, wherein
a rotation number of the opposite twist is less than or equal to a value obtained by dividing a total length of the intermediate part by an average circumferential length of the cable bundle.

6. The cable bundle according to claim 1, wherein
each of the connecting parts is a part of the cable between a first intersection of the first loop and a second intersection of the second loop, and
the connecting parts are wound in the first direction.

7. The cable bundle according to claim 6, wherein
the connecting parts of adjacent ones of the unit bundles in the stacking direction and an intermediate part connecting the unit bundles to each other form one circumference in the first direction.

8. The cable bundle according to claim 1, wherein
the first loop is formed by winding the cable in a normal winding or a reverse winding opposite to the normal winding, and
the second loop is formed by winding the cable in the reverse winding or the normal winding.

9. A method of manufacturing a cable bundle comprising a cable that is wound, the method comprising:
(a) forming unit bundles each of which comprises a first loop and a second loop that are connected via a respective one of connecting parts and are stacked; and
(b) stacking the unit bundles such that the connecting parts are disposed at different positions in a first direction that is a circumferential direction of the cable bundle, wherein
the first loop and the second loop are connected via a respective one of the connecting parts such that a figure-8 shaped loop including the first loop and the second loop is formed in a state in which each of the unit bundles is opened.

10. The method of manufacturing the cable bundle according to claim 9, wherein
step (a) comprises:
forming third loops each of which comprises the first loop and the second loop connected to each other via each of the connecting parts by disposing the cable in a figure-8 shape; and
forming the unit bundles by folding each of the third loops at each of the connecting parts and stacking the first loop and the second loop.

11. The method of manufacturing the cable bundle according to claim 9, wherein
step (a) comprises:
forming the first loop by twisting the cable in a third direction;
forming the second loop by twisting the cable in a fourth direction opposite to the third direction; and
forming each of the unit bundles by stacking the first loop and the second loop.

12. The method of manufacturing the cable bundle according to claim 9, wherein
the cable bundle comprises an intermediate part that is interposed between the unit bundles and connects the unit bundles to each other, and
step (b) comprises winding the intermediate part in the first direction such that the connecting parts of adjacent ones of the unit bundles are disposed at different positions within a range of 90 degrees to 270 degrees in the first direction.

13. A cable bundle manufacturing apparatus that manufactures a cable bundle comprising a cable that is wound, the cable bundle manufacturing apparatus comprising:
a fixer that fixes a movement of the cable in an axial direction of the cable at a fixed position on the cable;
a conveyor that conveys the cable toward the fixed position;
a twister that forms a loop of the cable by twisting the cable conveyed by the conveyor;
a first rotator that has a placement surface on which the loop formed by the twister is placed and stacked, and rotates the placement surface about a first axis substantially parallel to a normal direction of the placement surface.

14. The cable bundle manufacturing apparatus according to claim 13, wherein
the twister forms a first loop by twisting the cable in a third direction and forms a second loop by twisting the cable in a fourth direction opposite to the third direction.

15. The cable bundle manufacturing apparatus according to claim 13, comprising
a second rotator that rotates a drum that supplies the cable about a second axis substantially parallel to a direction in which the cable is sent out from the drum.
